(19) United States
(12) Patent Application Publication
(10) Pub. No.: US 2013/0328760 A1
(43) Pub. Date: Dec. 12, 2013

(54) Fast feature detection by reducing an area of a camera image

(71) Applicant: William Keith HONEA, San Diego, CA (US)

(72) Inventor: William Keith HONEA, San Diego, CA (US)

(73) Assignee: QUALCOMM Incorporated, San Diego, CA (US)

(21) Appl. No.: 13/492,686

(22) Filed: Jun. 8, 2012

(51) Int. Cl. G06K 9/68; G09G 3/36

(52) U.S. Cl. 345/156; 382/218

(57) ABSTRACT

An apparatus and method for a mobile device to reduce computer vision (CV) processing, for example, when detecting features and key points, is disclosed. Embodiments herein reduce the search area of an image or the volume of image data that is searched to detect features and key points. Embodiments limit a search area of a full image to an actual area of interest to the user. This reduction decreases the search area, decreases search time, decreases power consumption, and limits detection to the area of interest to the user.

### CROSS-REFERENCE TO RELATED APPLICATIONS

Not Applicable.

### BACKGROUND

I. Field of the Invention

This disclosure relates generally to apparatus and methods for computer vision (CV) processing, and more particularly to reducing an image area to be scanned for key points in order to determine features by using a CV algorithm.

II. Background

Various applications benefit from having a machine or processor that is capable of identifying objects and features in a picture. The field of computer vision attempts to provide techniques and/or algorithms that permit identifying objects and features in an image, where an object or feature may be characterized by descriptors identifying one or more key points. These techniques and/or algorithms are often also applied to face recognition, object detection, image matching, 3-dimensional structure construction, stereo correspondence, and/or motion tracking, among other applications. Generally, object or feature recognition may involve identifying points of interest (also called key points and feature points) in an image for the purpose of feature identification, image retrieval, and/or object recognition.

After the key points in an image are detected, they may be identified or described by using various descriptors. For example, descriptors may represent the visual features of the content in images, such as shape, color, texture, and/or rotation, among other image characteristics. The individual features corresponding to the key points and represented by the descriptors may then matched to a database of features from known objects. Such feature descriptors are increasingly finding applications in real-time object recognition, 3-D reconstruction, panorama stitching, robotic mapping, video tracking, and similar tasks. For additional information on key points and feature detection, see United States Patent Publication 2011/0299770 by Vaddadi et al. published Dec. 8, 2011 and titled “Performance of image recognition algorithms by pruning features, image scaling, and spatially constrained feature matching,” which is herein incorporated by reference in its entirety.

As a result, there is a need to improve feature detection techniques.

### BRIEF SUMMARY

Disclosed is an apparatus and method for indicating a reduced area of interest in a camera image using touch-screen feedback for faster feature detection, thereby reducing power consumption and improving user experience.

According to some aspects, disclosed is a method for defining a search area for a computer vision algorithm, the method comprising: displaying an image, captured by a camera, having a first area; receiving a selection by a user of a portion of the image; and defining, based on the portion of the image, a search area for a computer vision algorithm; wherein a search by the computer vision algorithm is limited to an area within the search area; and wherein the search area is reduced as compared to the first area.

According to some aspects, disclosed is a mobile device to define a search area for a computer vision algorithm, the mobile device comprising: a camera; a user input device; memory; and a processor coupled to the camera, the user input device and the memory; wherein the processor is coupled to receive images from the camera, to receive user input from the user input device, and to load and store data to the memory; and wherein the memory comprises code, when executed on the processor, for: displaying an image, captured by the camera, having a first area; receiving a selection by a user, via the input device, of a portion of the image; and defining, based on the portion of the image, a search area for a computer vision algorithm; wherein a search by the computer vision algorithm is limited to an area within the search area; and wherein the search area is reduced as compared to the first area.

According to some aspects, disclosed is a mobile device to define a search area for a computer vision algorithm, the mobile device comprising: means for displaying an image having a first area; means for receiving a selection by a user of a portion of the image; and means for defining, based on the portion of the image, a search area for a computer vision algorithm; wherein a search by the computer vision algorithm is limited to an area within the search area; and wherein the search area is reduced as compared to the first area.

According to some aspects, disclosed is a non-transitory computer-readable medium including program code stored thereon, the program code comprising code for: displaying an image having a first area; receiving a selection by a user of a portion of the image; and defining, based on the portion of the image, a search area for a computer vision algorithm; wherein a search by the computer vision algorithm is limited to an area within the search area; and wherein the search area is reduced as compared to the first area.

It is understood that other aspects will become readily apparent to those skilled in the art from the following detailed description, wherein it is shown and described various aspects by way of illustration. The drawings and detailed description are to be regarded as illustrative in nature and not as restrictive.

### BRIEF DESCRIPTION OF THE DRAWING

Embodiments of the invention will be described, by way of example only, with reference to the drawings.

FIG. 1 shows modules of a mobile device, in accordance with some embodiments.

FIG. 2 shows a mobile device displaying an image.

FIG. 3 shows a default search area encompassing an area of a displayed image.

FIG. 4 shows the key points, which may be detected in an image after searching.

FIG. 5 shows a user interacting with a mobile device.

FIGS. 6-9 show features and key points within a user selected search area identified with a touch-screen display of a mobile device, in accordance with some embodiments.

FIG. 10 shows a method to limit a search of a displayed image, in accordance with some embodiments.

### DETAILED DESCRIPTION

The detailed description set forth below in connection with the appended drawings is intended as a description of various aspects of the present disclosure and is not intended to represent the only aspects in which the present disclosure may be practiced. Each aspect described in this disclosure is provided merely as an example or illustration of the present disclosure, and should not necessarily be construed as preferred or advantageous over other aspects. The detailed description includes specific details for the purpose of providing a thorough understanding of the present disclosure. However, it will be apparent to those skilled in the art that the present disclosure may be practiced without these specific details. In some instances, well-known structures and devices are shown in block diagram form in order to avoid obscuring the concepts of the present disclosure. Acronyms and other descriptive terminology may be used merely for convenience and clarity and are not intended to limit the scope of the disclosure.

As used herein, a mobile device 100, sometimes referred to as a mobile station (MS) or user equipment (UE), such as a cellular phone, mobile phone or other wireless communication device, personal communication system (PCS) device, personal navigation device (PND), Personal Information Manager (PIM), Personal Digital Assistant (PDA), laptop or other suitable mobile device which is capable of receiving wireless communication and/or navigation signals. The term “mobile station” is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile station” is intended to include all devices, including wireless communication devices, computers, laptops, etc. which are capable of communication with a server, such as via the Internet, WiFi, or other network, and regardless of whether satellite signal reception, assistance data reception, and/or position-related processing occurs at the device, at a server, or at another device associated with the network. Any operable combination of the above are also considered a “mobile device 100.” Those of skill in the art will recognize, however, that embodiments described below may not require a mobile device 100 for operation. In at least some embodiments, methods and/or functions described below may be implemented on any device capable of displaying an image and receiving a user input.

As the resolution of cameras in mobile and handheld devices increases, the amount of data that is searched by computer vision algorithms, for example to identify key points 210, similarly increases. This large volume of data results in slower detection times and increased power consumption as well as the detection of erroneous features. Additionally, with very busy or cluttered images, a user may only be interested in detecting features in a limited portion of the full image. Further, transmission and/or storage of feature descriptors (or equivalent) may limit the computation speed of object detection and/or the size of image databases. In the context of mobile devices (e.g., camera phones, mobile phones, certain cameras, etc.) or distributed camera networks, significant communication and power resources may be spent in transmitting information (e.g., including an image and/or image descriptors) between nodes. Feature descriptor compression hence may be important for reduction in storage, latency, and transmission.

Embodiments herein provide a method for reducing the area of an image or the volume of image data that must be searched. Embodiments limit an area of a full image to an actual area of interest to the user. This reduction may decrease the area searched, decrease search time, decrease power consumption, and/or limit detection to only the area of interest to the user.

In some embodiments, a user directs a camera of his mobile device at a scene in which there is something of interest. The user may define an area by using a finger on a touch screen of the mobile device in a discovery mode and encircle an object or objects of interest (such as a building in the city, an item on a table, or other object within a much larger and possibly busier image). A user defined area may be a circle, free-style loop or other closed shape. For example, a red line that follows the outline of the user's finger is shown on the screen as feedback to indicate where the user has drawn. Once the outline of the object is complete, the user taps once on the screen to indicate the user is finished selecting the area of interest. A processor of the mobile device accepts a tapping by the user then moves from discovery mode to detection mode. For example, the device may indicate a mode change by changing the outline highlight from red to green. The outline provided by the user may be treated as a reduced area of interest. In some embodiments, this reduced area of interest in the image selected by the user is then searched for a detection of key points. Often, the reduced area (a first area) selected by the user may be much smaller than the entire image displayed to the user. For example, the reduced area may be less than 50% of the full image area. Therefore, searching the reduced-sized image would take at least half the amount of time and fewer resources, and would make detection much faster and easier. Furthermore, the processor only searches for features that are of interest to the user.

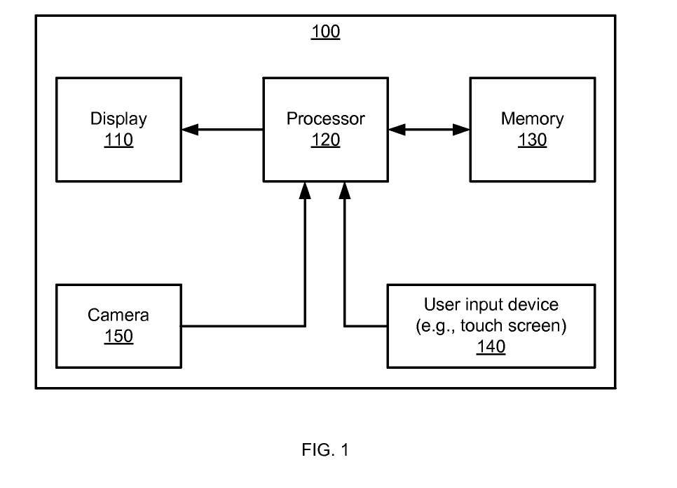

FIG. 1 shows modules of a mobile device 100, in accordance with some embodiments. The mobile device 100 includes a display 110, a processor 120, memory 130, a user input device 140 and a camera 150. The processor 120 is coupled to the display 110, which may be any of the various displays found on mobile and handheld devices. The processor 120 is also coupled to the memory 130 to load and store data to the memory 130. The memory 130 contains instructions to perform the methods and operations described herein. The memory 130 may contain data captured by the user input device 140 and camera 150 as well as interim data computed by the processor 120. The processor 120 is coupled to the user input device 140, which may be a touch screen integrated with the display 110, a separate touch pad, or a joystick, keypad, or other input device. The processor 120 is also coupled to the camera 150 to receive images captured by the camera 150. The images may be still images or movie streams, which may be saved by the processor 120 directly or indirectly to memory 130.

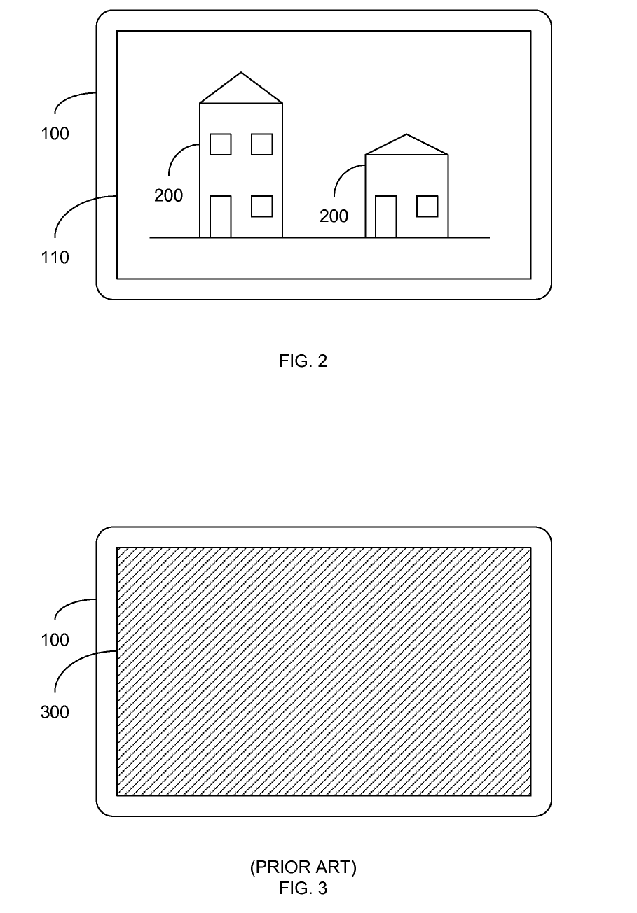

FIG. 2 shows a mobile device 100 displaying an image. The image may contain one or more objects 200, for example, buildings, faces, artificial objects, natural objects and/or scenery. The image on the display 110 may be dynamic until the user takes a snapshot or enters a command (e.g., with a finger gesture across the display 110 or by providing another input) or the image may have been previously captured by the mobile device 100 or communicated to the mobile device 100.

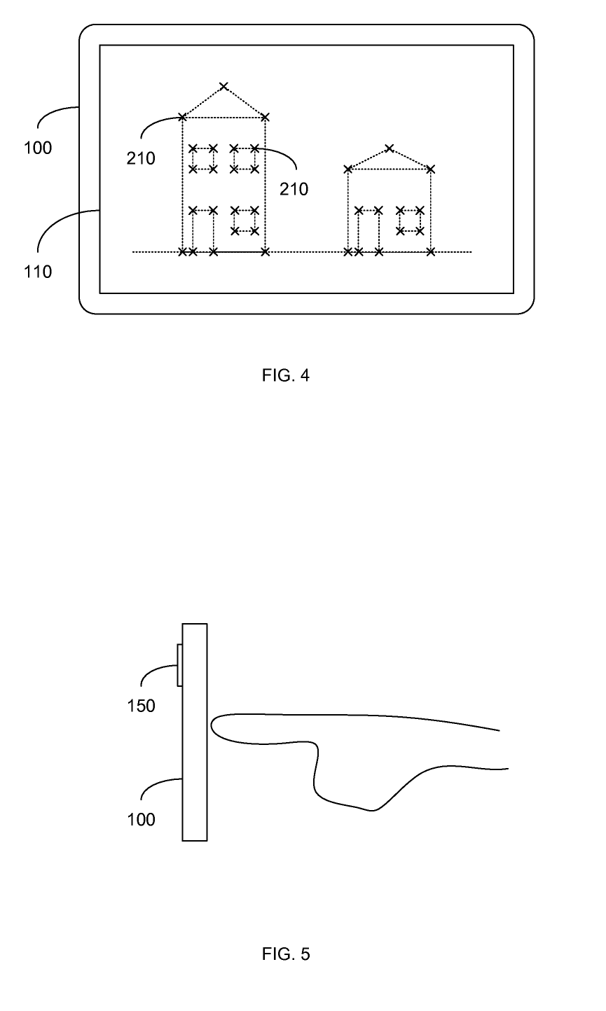

FIG. 3 shows a default search area encompassing an area 300 of a displayed image. In prior art systems, an area 300 of the entire image is processed to seek features and key points 210. FIG. 4 shows an example of key points 210, which may be detected in an image after searching. The key points 210 are laid over the original image. In this case, most of the area 300 was void of any features or key points 210. Processing such an area 300 may be reduced by selecting and/or reducing a search area 320 or user defined area as described below.

According to embodiments, a user selects one or more portions of an image. In the example image shown, processing such an area 300 results in processing vast areas without any features or key points 210. If a user is interested in only some of an image's features, the prior art system still processes the area 300 and as a result scans portions of an image void of features and/or detects features of no or little interest to the user. For example, a particular image contains several buildings and a face. A prior art system scans the area 300 resulting in features and key points 210 from the face and the several buildings (objects 200) even though the user may have been interested in just features from a single building or other object. Instead of scanning an area 300, embodiments described herein allow a user to select one or more subareas, for example, as delineated by a user defined line 310; scan just a search area 320, for example, as identified by the user defined line 310, based on the selected subareas; and exclude processing of areas outside of the search area 320, but within the area 300, thereby detecting features and key points 210 within just the search area 320.

FIG. 5 shows a user interacting with a mobile device 100. In FIG. 5, an image (e.g., an image captured with a camera 150 on the mobile device 100) is displayed on display 110. With a touch-screen display or other user input device 140, the user selects an area or areas of the image.

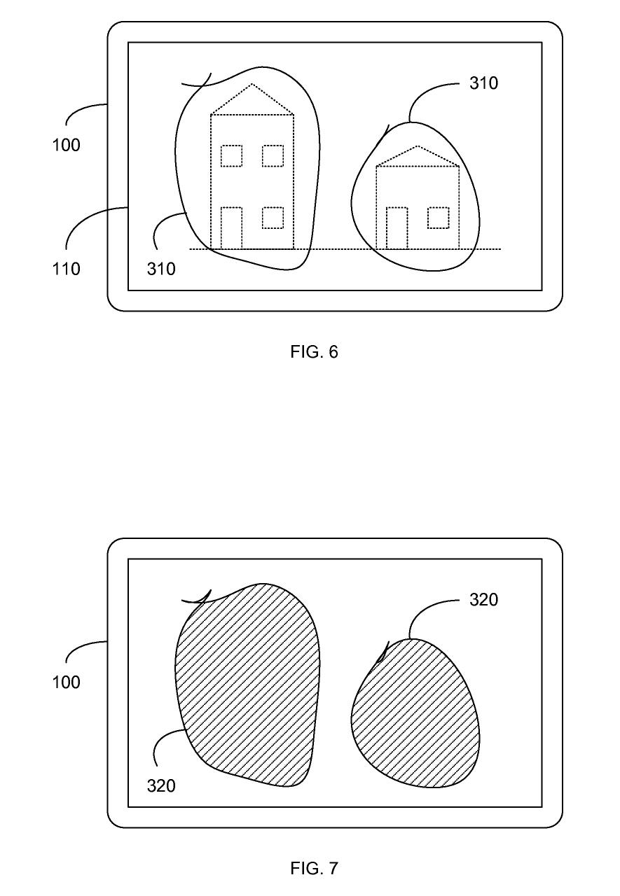

FIGS. 6-9 show features and key points 210 within a user selected search area 320 identified with a touch-screen display of a mobile device 100, in accordance with some embodiments. For example, in FIG. 6, a user has just drawn two user defined lines 310 (to define corresponding search areas 320, which may be two disjoint regions of the image captured by a camera) by dragging his finger across the user input device 140 to loop one or more desired objects. FIG. 7 shows the resulting search areas 320 after a user has completed lassoing the search areas 320 by dragging his finger across the image, thereby isolating the two buildings.

Alternatively, processing may be limited to just one search area 320 rather than two search areas 320, as shown. Alternatively, processing may allow multiple search areas 320 to be defined by the user, for example, two, three, or more search areas 320. In some embodiments, a user may select a first of the search areas 320 to process, and may then choose whether or not to process a second of the search areas 320, for example based on whether an object of interest was identified in the first of the search areas 320. The search area 320 eliminates feature detection and processing in the non-selected area. Mathematically, the non-selected area is one or more areas defined by the spatial difference between the area 300 and the search area 320 (e.g., as defined by the user defined line(s) 310).

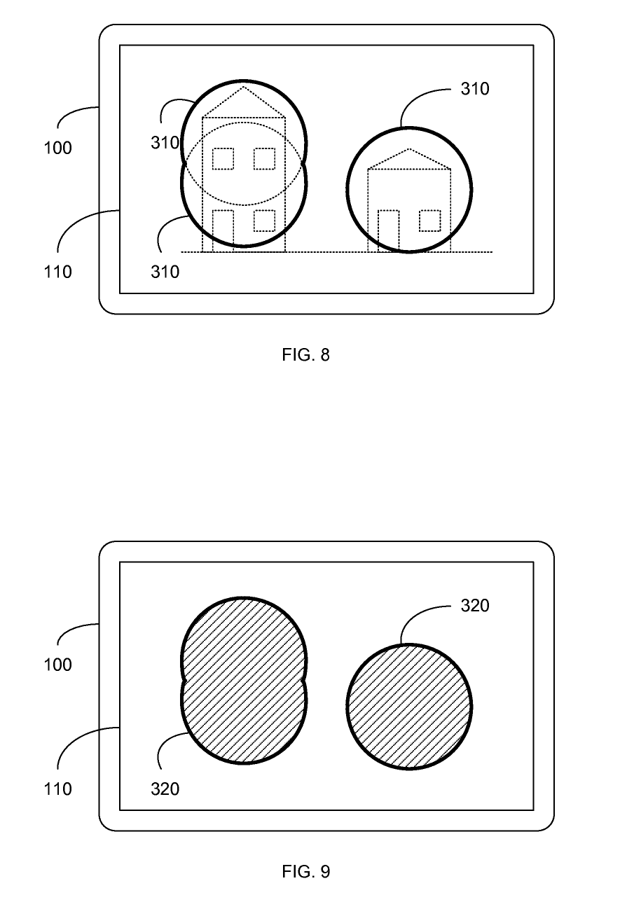

FIGS. 8 and 9 show an alternate set of user defined lines 310 and search areas 320, respectively. Instead of dragging and lassoing a search area 320, a user may tap at the center of a circle creating a fixed radius circle that indicates the user defined line 310 (and thus defines a search area 320). A user may use a pinching technique using two fingers to reduce or enlarge a circle, oval or other shape to result in the search area 320. Other inputs may be used to define a search area or to adjust a previously inputted search area 320. In some embodiments, the search area 320 may be defined as a region outside of an enclosed area. For example, instead of inputting the search areas 320 into a computer vision (CV) algorithm, the search areas 320 may be omitted and the area outside of the search areas 320 may be searched or otherwise inputted into a CV algorithm.

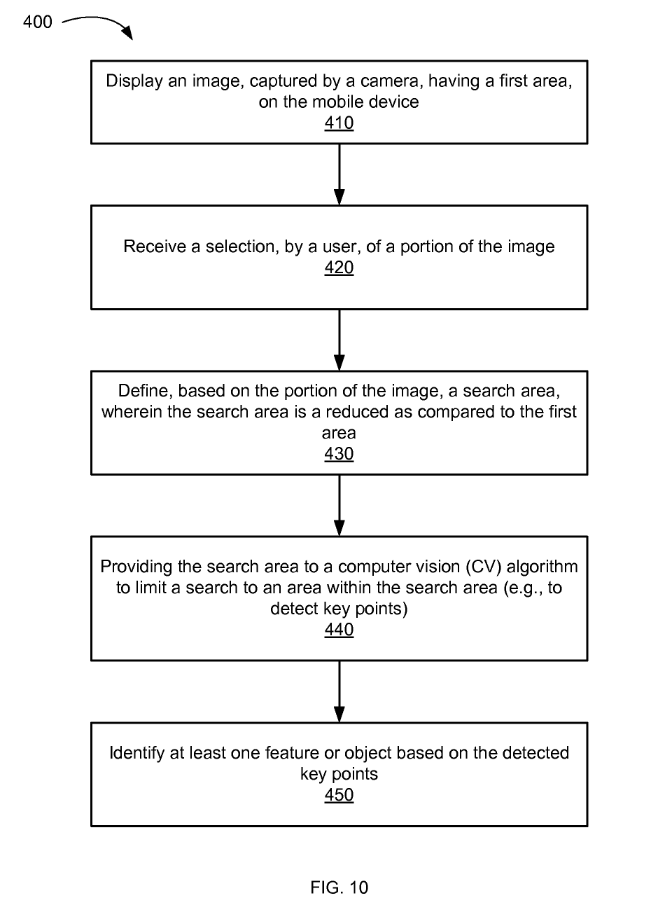

FIG. 10 shows a method 400 for defining a search area for a computer vision algorithm, in accordance with some embodiments. At step 410, the processor 120 displays an image, captured by a camera, having a first area, on the mobile device 100. For example, the displayed image may have been captured by a camera at the mobile device 100 or, alternatively, at another device, and may contain one or more key points 210 and/or objects. The displaying of the image may occur on a touch screen and is of a first area.

At step 420, the processor 120 receives a selection (e.g., by a user defined line 310), from a user, of a portion of the image. For example, the processor 120 may receive user input, such as one or more center points, line segments or closed loops, from a touch screen. Such user defined lines 310 define a selection from a user. At step 430, the processor 120 defines, based on the user selection, at least one search area (e.g., search area 320) possibly containing key points 210. The search area 320 is limited to an area within the first area of the image. The search area 320 may be a circle, oval, polygon or a free-form area drawn by the user. At step 440, the processor 120 provides the search area 320 to a CV algorithm to detect key points 210, features and/or objects. The CV algorithm limits a search to the search area 320.

The CV algorithm may run locally on the processor 120 or remotely on a separate processor, such as a server on the network. In the case that the CV algorithm runs partially or wholly on a remote server, uplink information (e.g., a definition of the first area and/or search area 320) may be communicated from the mobile device 100 to the server. For example, the mobile device 100 may transmit uplink information regarding the search area 320 and which one or more sections of the image are to be omitted or included during a search. In some embodiments, no information is transmitted for portions of the area 300 which are not included in the search area 320. A remote device, such as a server, may perform at least part of the computer vision algorithm. The server may search the search area 320 for one or more key points 210. The server then may use key points 210 to recognize or identify one or more features and/or one or more objects. Next, the server may communicate to the mobile device 100 downlink information (e.g., the one or more identified key points 210, features and/or objects).

Equally, some or all of the functions of the server described herein may be performed by the CV algorithm on the processor 120 of the mobile device 100. That is, the processor 120 may execute the computer vision algorithm entirely or partially on a mobile device 100. For example, the computer vision algorithm may identify features of the object based on the key points 210, and then, based at least in part on, recognize and match the identified features to known features of an object.

If the mobile device 100 receives one or more key points 210, at step 450, the processor 120 may recognize or identify at least one feature and/or at least one object based on a result of the search (e.g., the key points 210.) The identified features and/or objects may be used as inputs to an AR (augmented reality) application in some embodiments. The processor 120 may act to operate the AR application based at least in part on a result of the computer vision algorithm, which may also be performed on the processor 120. Finally, the processor 120 may display the one or more key points 210, features and/or objects in the AR application based at least in part on a result of the computer vision algorithm. For example, the AR application may use the key points 210 and/or identified features or objects to anchor an animated or computer generated icon, object or character over the image and then display a composite image containing the animation. In this way, the amount of processing and/or power consumed may be reduced when operating an AR application or another type of application. Further, a user of an AR application may reduce or otherwise limit a search area for an AR application or may identify a region or regions that are of interest to the user with respect to the AR application. Augmentations provided by the AR application may thus be ensured for the region or regions of interest or limited to that region or those regions, for example.

In some embodiments, a display 110, such as a touch screen display, on the mobile device 100 acts as a means for displaying an image having a first area. Alternatively, in some embodiments, the processor 120 acts as a means for displaying an image having a first area. In some embodiments, the processor 120 and/or a server run a computer vision algorithm, acts as a means for receiving a selection by a user of a portion of the image, and/or acts as a means for defining, based on the portion of the image, a search area for the computer vision algorithm.

The methodologies described herein may be implemented by various means depending upon the application. For example, these methodologies may be implemented in hardware, firmware, software, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory and executed by a processor unit. Memory may be implemented within the processor unit or external to the processor unit. As used herein the term “memory” refers to any type of long term, short term, volatile, non-volatile, transitory, non-transitory, or other memory and is not to be limited to any particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure.

What is claimed is:

1. A method for defining a search area for a computer vision algorithm, the method comprising:
displaying an image, captured by a camera, having a first area;
receiving a selection by a user of a portion of the image; and
defining, based on the portion of the image, a search area for a computer vision algorithm;
wherein a search by the computer vision algorithm is limited to an area within the search area; and
wherein the search area is reduced as compared to the first area.

2. The method of claim 1, further comprising recognizing an object in the image based on a result of the search.

3. The method of claim 2, wherein the search comprises searching the search area for key points.

4. The method of claim 3, wherein the computer vision algorithm comprises identifying features of the object based on the key points, and wherein the recognizing is based at least in part on matching the identified features to known features of the object.

5. The method of claim 1, further comprising performing the computer vision algorithm on a mobile device.

6. The method of claim 1, further comprising transmitting information regarding the search area to a remote device to perform at least part of the computer vision algorithm, wherein the transmitted information excludes at least a portion of the image outside of the search area.

7. The method of claim 1, further comprising operating an augmented reality application based at least in part on a result of the computer vision algorithm.

8. The method of claim 1, wherein the displaying comprises displaying the image on a touch screen, and wherein the receiving of the selection comprises receiving an input on the touch screen.

9. The method of claim 1, wherein the selection comprises at least one user defined line.

10. The method of claim 9, wherein the search area comprises a polygon.

11. The method of claim 9, wherein the search area comprises a circle.

12. The method of claim 9, wherein the search area comprises a free-form area.

13. The method of claim 1, wherein receiving the selection comprises accepting a tapping by the user.

14. The method of claim 1, wherein the search area comprises at least two disjoint regions of the image.

15. A mobile device to define a search area for a computer vision algorithm, the mobile device comprising:
a camera;
a user input device;
memory; and
a processor coupled to the camera, the user input device and the memory;
wherein the processor is coupled to receive images from the camera, to receive user input from the user input device, and to load and store data to the memory; and
wherein the memory comprises code, when executed on the processor, for:
displaying an image, captured by the camera, having a first area;
receiving a selection by a user, via the input device, of a portion of the image; and
defining, based on the portion of the image, a search area for a computer vision algorithm;
wherein a search by the computer vision algorithm is limited to an area within the search area; and
wherein the search area is reduced as compared to the first area.

16. The mobile device of claim 15, the code further comprises code for recognizing an object in the image based on a result of the search.

17. The mobile device of claim 16, wherein the search comprises searching the search area for key points.

18. The mobile device of claim 17, wherein the computer vision algorithm comprises identifying features of the object based on the key points, and wherein the recognizing is based at least in part on matching the identified features to known features of the object.

19. The mobile device of claim 15, the code further comprises code for performing the computer vision algorithm on a mobile device.

20. The mobile device of claim 15, the code further comprises code for transmitting information regarding the search area to a remote device to perform at least part of the computer vision algorithm, wherein the transmitted information excludes at least a portion of the image outside of the search area.

21. The mobile device of claim 15, the code further comprises code for operating an augmented reality application based at least in part on a result of the computer vision algorithm.

22. The mobile device of claim 15, wherein the search area comprises at least two disjoint regions of the image.

23. The mobile device of claim 15, wherein code for accepting the selection comprises code for drawing at least one user defined line.

24. The mobile device of claim 15, wherein the search area comprises a circle.

25. The mobile device of claim 15, wherein the search area comprises a free-form area.

26. The mobile device of claim 15, wherein code for receiving the selection comprises code for receiving a tapping by the user.

27. A mobile device to define a search area for a computer vision algorithm, the mobile device comprising:
means for displaying an image having a first area;
means for receiving a selection by a user of a portion of the image; and
means for defining, based on the portion of the image, a search area for a computer vision algorithm;
wherein a search by the computer vision algorithm is limited to an area within the search area; and
wherein the search area is reduced as compared to the first area.

28. The mobile device of claim 27, wherein means for accepting the selection comprises means for drawing at least one user defined line.

29. The mobile device of claim 27, wherein the search area comprises a circle.

30. The mobile device of claim 27, wherein the search area comprises a free-form area.

31. A non-transitory computer-readable medium including program code stored thereon, the program code comprising code for:
displaying an image having a first area;
receiving a selection by a user of a portion of the image; and
defining, based on the portion of the image, a search area for a computer vision algorithm;
wherein a search by the computer vision algorithm is limited to an area within the search area; and
wherein the search area is reduced as compared to the first area.

32. The non-transitory computer-readable medium of claim 31, wherein the code for accepting the selection comprises code for drawing at least one user defined line.

33. The non-transitory computer-readable medium of claim 31, wherein the search area comprises a circle.

34. The non-transitory computer-readable medium of claim 31, wherein the search area comprises a free-form area.
